(19) United States
(12) Patent Application Publication
(10) Pub. No.: US 2011/0259457 A1
(43) Pub. Date: Oct. 27, 2011

(54) Joint Structure for Controlling Water Flow

(76) Inventor: Wen-Tsung Lin, Dacheng Township (TW)

(21) Appl. No.: 12/766,065

(22) Filed: Apr. 23, 2010

(51) Int. Cl. F16K 11/10

(52) U.S. Cl. 137/625.46

(57) ABSTRACT

A joint structure for controlling water flow contains a first joint including an outer connecting portion disposed on one end thereof, a larger-diameter fitting portion mounted on another end thereof to receive a first stopping ring, and a closed surface fixed on a top end of the larger-diameter fitting portion, the closed surface including a plurality of limiting bores attached thereon; a second joint including an inner connecting portion disposed on one end thereof, a small-diameter fitting portion mounted on another end thereof, and openings defined therein; an adjusting member including a partition mounted therein, the partition including an orifice formed thereon, and two ends of the adjusting member being used to fit the first and the second joints axially so that the first joint is connected with the second joint, and the adjusting member is located between the first and the second joints to rotate relatively.

### BACKGROUND OF THE INVENTION

1. Field of the Invention

The present invention relates to a flow controlling device, and more particularly to a joint structure for controlling water flow that is installed to watering piping and outlet equipment.

2. Description of the Prior Art

A convention water flow limiting structure as shown in FIGS. 14 and 15 contains a first tube 10 communicating with an outlet outside, a second tube 20 communicating with an inlet of a reverse osmosis valve, and an adjusting portion 30 integrally fixed to the first tube 10, a conducting portion 40 integrally fixed to the second tube 20, however a connecting pipe is deformed with rotation of the conducting portion 40 to influence water flow.

Referring to FIGS. 16 and 17, a convention water flow controlling valve includes a rotary cover 50 to be rotated to control water flow, but water is stopped as it flows. Furthermore, the rotary cover 50 is disposed to one side of the valve member 60, therefore the water flow controlling valve is limited to be installed in a certain direction, limiting operation and installation.

The present invention has arisen to mitigate and/or obviate the afore-described disadvantages.

### SUMMARY OF THE INVENTION

The primary object of the present invention is to provide a joint structure for controlling water flow that the adjusting member is rotated directly, and the first and the second joints are still to prevent the outlet pipes from deformation so that water flows directly and smoothly without being stopped.

Another object of the present invention is to provide a joint structure for controlling water flow that the adjusting member is rotated directly, and the first and the second joints are still to prevent the outlet pipes from being actuated to rotate by the adjusting member, such that the joint structure is applicable to hard pipes, and the adjusting member is installed between the first and the second joints to be on the same axle center as the first and second joints, hence the adjusting member is operated easily without being limited.

To obtain the above objectives, a joint structure for controlling water flow provided by the present invention comprises

a first joint being hollow, including a first connecting portion disposed on one end thereof, and including a larger-diameter fitting portion mounted on another end thereof to receive a first stopping ring, including a closed surface fixed on a top end of the larger-diameter fitting portion, and the closed surface including a plurality of limiting bores attached thereon;

a second joint being hollow, including a second connecting portion disposed on one end thereof, including a small-diameter fitting portion mounted on another end thereof, and including openings defined therein;

an adjusting member formed in a circular cylinder and including a partition mounted therein, the partition including an orifice formed thereon, and two ends of the adjusting member being used to fit the first and the second joints axially so that the first joint is connected with the second joint, and the adjusting member is located between the first and the second joints to rotate relative to the first and the second joints.

### BRIEF DESCRIPTION OF THE DRAWINGS

FIG. 1 is a perspective view showing the exploded components of a joint structure for controlling water flow according to a first embodiment of the present invention;

FIG. 1-1 is a perspective view showing the assembly of a first joint of the joint structure for controlling water flow according to the first embodiment of the present invention;

FIG. 2 is a perspective view showing the assembly of the joint structure for controlling water flow according to the first embodiment of the present invention;

FIG. 3 is a cross sectional view showing the assembly of the joint structure for controlling water flow according to the first embodiment of the present invention;

FIG. 4 is a cross sectional view showing a water flowing state of the joint structure for controlling water flow according to the first embodiment of the present invention;

FIG. 5 is a cross sectional view showing the operation of the joint structure for controlling water flow according to the first embodiment of the present invention;

FIG. 6 is a cross sectional view showing the joint structure for controlling water flow being installed between a shower head and an inlet pipe according to the first embodiment of the present invention;

FIG. 7 is a side plan view showing the joint structure for controlling water flow being installed between an outlet pipe and a faucet according to the first embodiment of the present invention;

FIG. 8 is a side plan view showing the joint structure for controlling water flow being installed to a middle section of a watering piping according to the first embodiment of the present invention;

FIG. 9 is a perspective view showing the exploded components of a joint structure for controlling water flow according to a second embodiment of the present invention;

FIG. 9-1 is a perspective view showing the assembly of a first joint of the joint structure for controlling water flow according to the second embodiment of the present invention;

FIG. 10 is a cross sectional view showing the assembly of the joint structure for controlling water flow according to the second embodiment of the present invention;

FIG. 11 is a perspective view showing the exploded components of a joint structure for controlling water flow according to a third embodiment of the present invention;

FIG. 11-1 is a perspective view showing the assembly of a first joint of the joint structure for controlling water flow according to the third embodiment of the present invention;

FIG. 12 is a cross sectional view showing the assembly of the joint structure for controlling water flow according to the third embodiment of the present invention;

FIG. 13 is a perspective view showing the exploded components of a joint structure for controlling water flow according to a fourth embodiment of the present invention;

FIG. 13-1 is a perspective view showing the assembly of a first joint of the joint structure for controlling water flow according to the fourth embodiment of the present invention;

FIG. 14 is a perspective view showing the exploded components of a conventional water flow limiting structure;

FIG. 15 is a cross sectional view showing the assembly of the conventional water flow limiting structure;

FIG. 16 is a perspective view showing the exploded components of a conventional water flow controlling valve;

FIG. 17 is a cross sectional view showing the assembly of the conventional water flow controlling valve.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

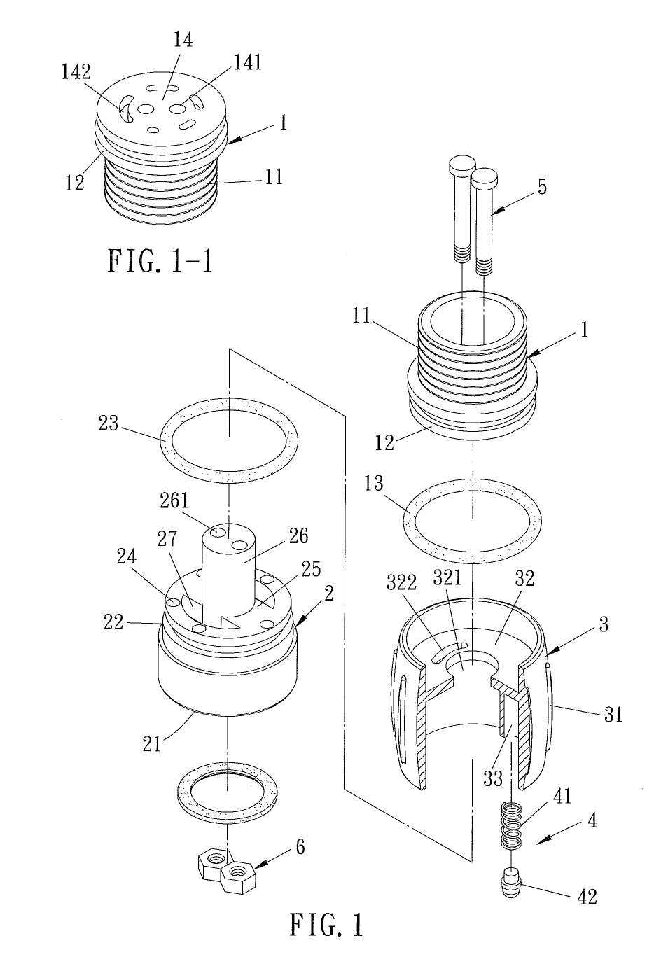

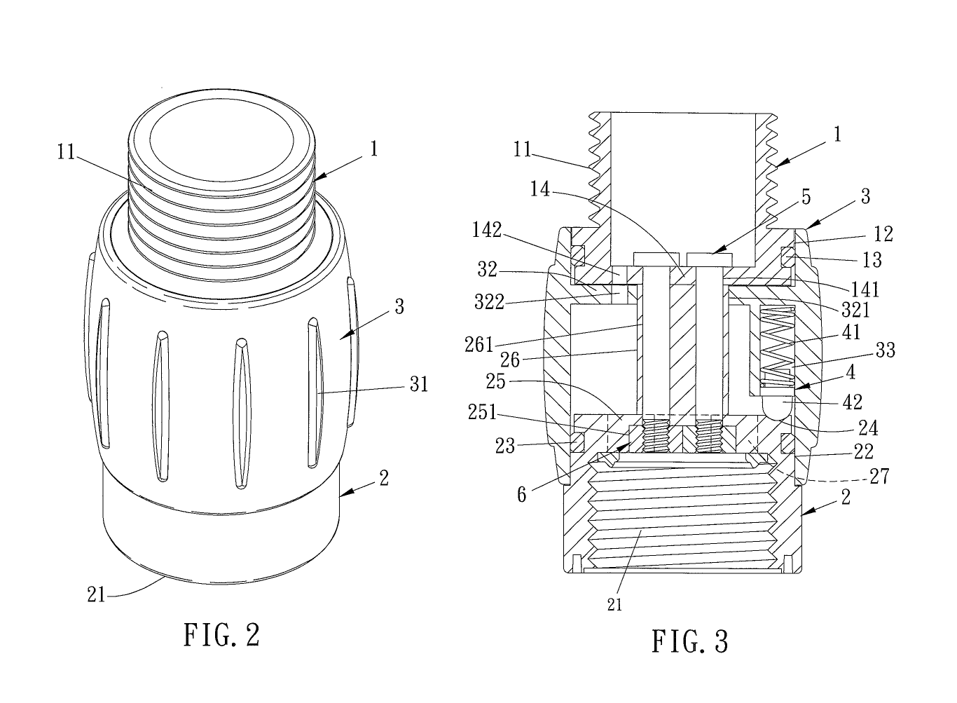

With reference to FIGS. 1-3, a joint structure for controlling water flow in accordance with a first embodiment of the present invention includes a first joint 1, a second joint 2, an adjusting member 3, a positioning unit 4, and two locking elements 5, wherein the first joint 1 is hollow and circular, includes first connecting portion (e.g., an outer connecting portion 11) disposed on one end thereof, and includes a larger-diameter fitting portion 12 mounted on another end thereof, the larger-diameter fitting portion 12 includes an annular groove formed around an peripheral side thereof to receive a first stopping ring 13, the first joint 1 also includes a closed surface 14 fixed on a top end of the larger-diameter fitting portion 12, and the closed surface 14 includes two through holes 141 arranged around a center thereof and a plurality of elongately arcuate limiting bores 142 attached around the through holes 141; the second joint 2 is hollow and circular, includes a second connecting portion (e.g., an inner connecting portion 21) disposed on one end thereof and includes a small-diameter fitting portion 22 mounted on another end thereof, the small-diameter fitting portion 22 includes an circular recess formed around an peripheral side thereof to receive a second stopping ring 23, and the second joint 2 also includes a number of curve fixing notches 24 fixed around a top end surface of the small-diameter fitting portion 22, a plate 25 secured on the top end surface thereof, and a column 26 extending outward from a central section of the plate 25, and the column 26 includes two apertures 261 formed thereon, the plate 25 includes a retaining trough 251 disposed therein, and between the plate 25 and an inner peripheral side of the second joint 2 are defined two openings 27; the adjusting member 3 is formed in a circular cylinder and includes a plurality of anti-slid ribs 31 disposed around an outer periphery thereof, and includes a partition 32 mounted on a top end of an inner side thereof, the partition 32 includes a circular mouth 321 fixed on a center thereof and an elongately arcuate orifice 322 formed around the mouth 321, and the adjusting member 3 also includes a receiving seat 33 arranged therein to receive the positioning unit 4; the positioning unit 4 is comprised of a spring 41 and a biasing element 42; the locking element 5 is a bolt.

In assembly, the spring 41 and the biasing element 42 of the positioning unit 4 are installed to the receiving seat 33 of the adjusting member 3, and the first and the second joints 1, 2 are fitted to two ends of the adjusting member 3 by using the larger-diameter and the small-diameter fitting portions 12, 22 respectively, then the locking elements 5 are inserted through the through holes 141 of the first joint 1 and the apertures 261 of the column 26 of the second joint 2 to screw with nuts 6 which are fixed in the retaining trough 251 of the plate 25 of the second joint 2 so that the first joint 1 is connected with the second joint 2, and the adjusting member 3 is located between the first and the second joints 1, 2 to rotate relative to the first and the second joints 1, 2, thus finishing assembly.

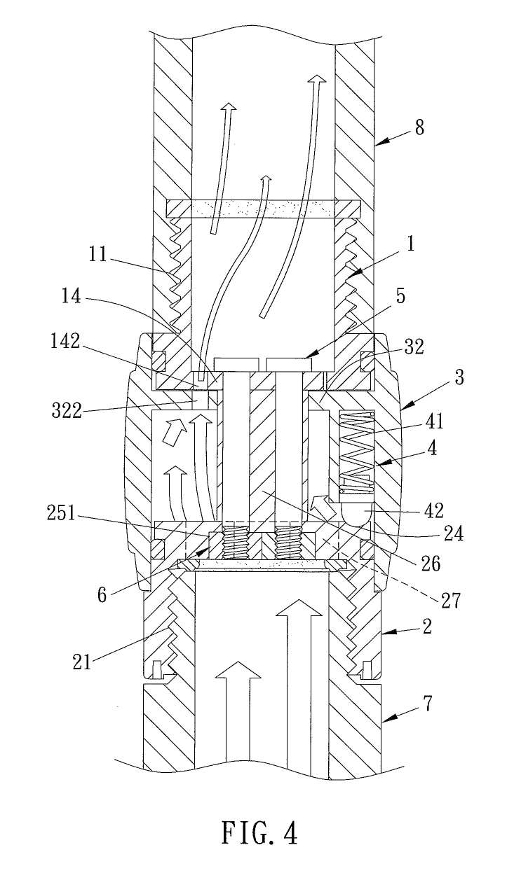

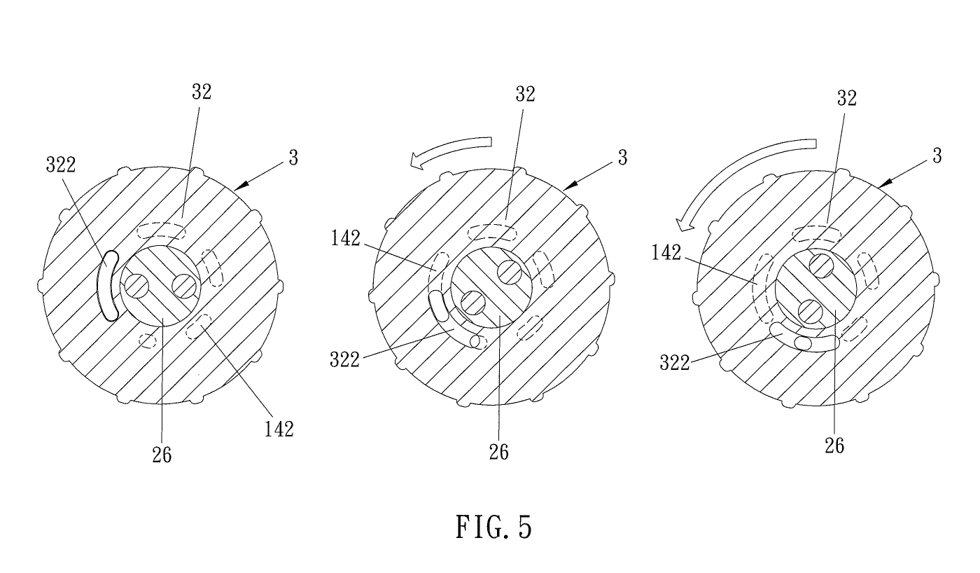

In operation, as shown in FIGS. 4 and 5, the outer connecting portion 11 of the first joint 1 and the inner connecting portion 21 of the second joint 2 are fitted to outlet pipes 7 and 8 individually so that water flows to the adjusting member 3 from the openings 27 of the second joint 2 and flows out of the first joint 1 via the orifice 322 of the adjusting member 3 and the limiting bores 142 of the first joint 1. Thereafter, the adjusting member 3 is rotated based on requirement to change an engagement between the orifice 322 of the adjusting member 3 and the limiting bores 142 of the first joint 1, wherein when the adjusting member 3 is rotated to a fixing position, the biasing element 42 of the positioning unit 4 is pushed by the spring 41 to retain with the fixing notch 24 to control water flow, thereby saving water and enhancing watering pressure.

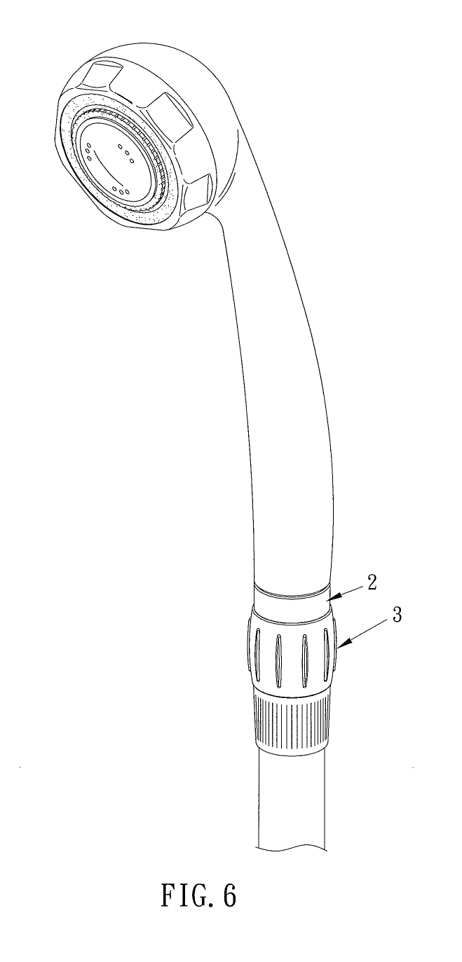

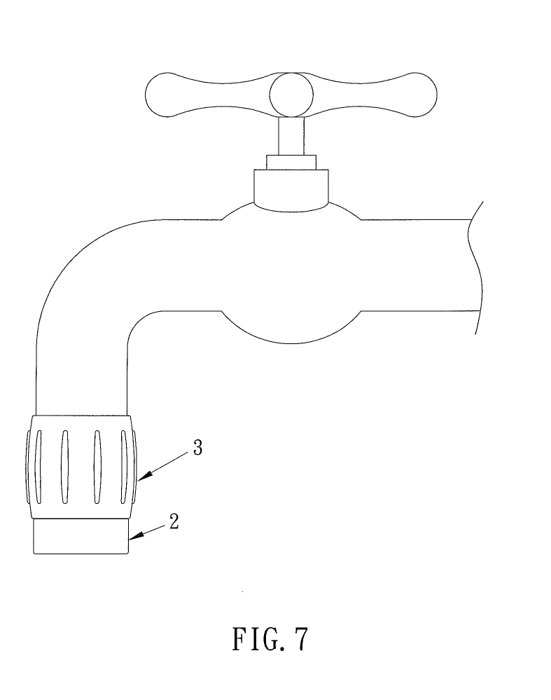

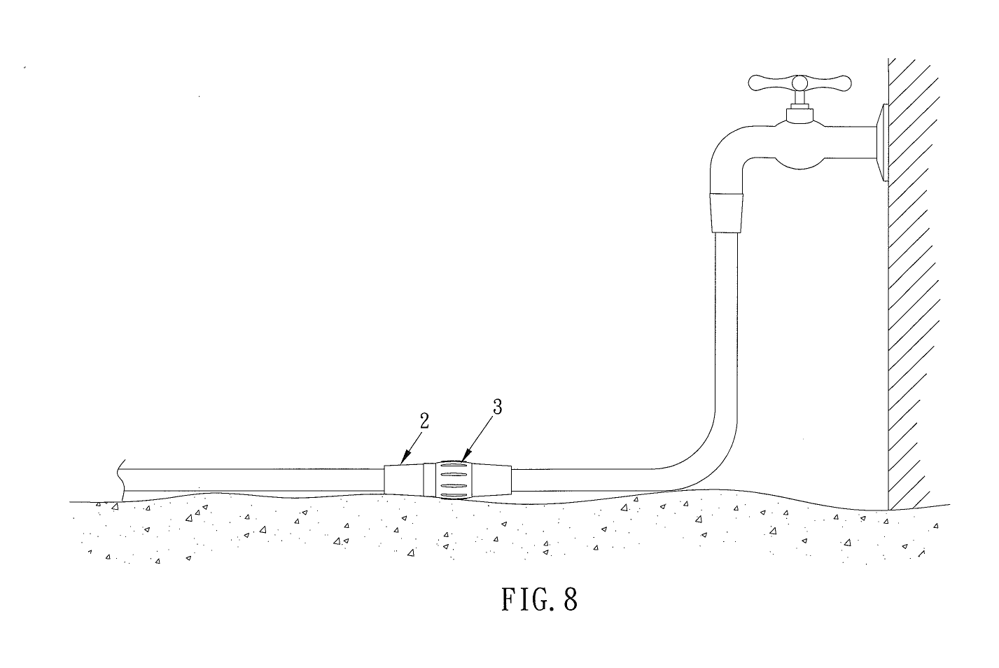

The joint structure of the present invention is installed between a shower head and an inlet pipe as shown in FIG. 6, installed to an outlet of a faucet as illustrated in FIG. 7, and installed to a middle section of a watering piping as shown in FIG. 8, or installed between other outlet equipments, inlet and outlet pipes.

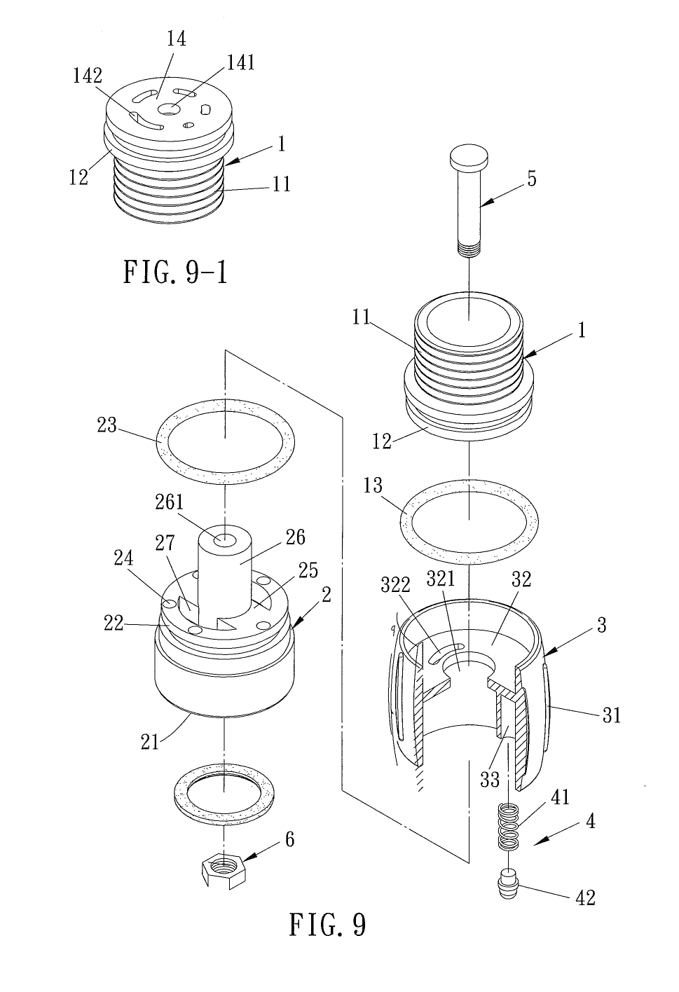

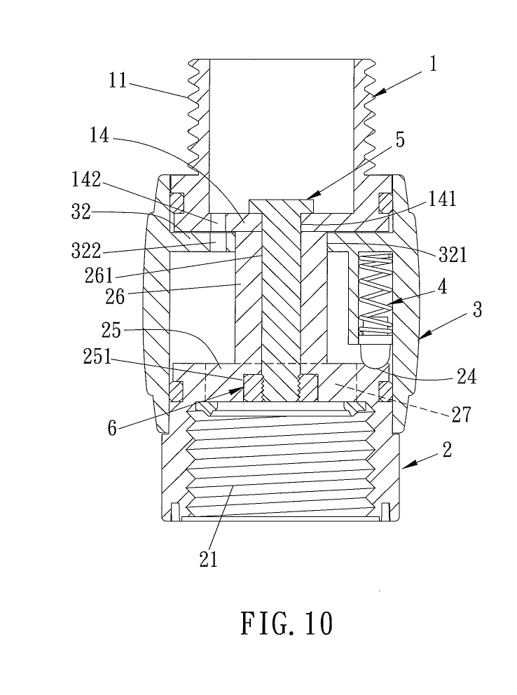

Referring to FIGS. 9 and 10, a joint structure for controlling water flow in accordance with a second embodiment of the present invention comprises a first joint 1 includes a closed surface 14, and the closed surface 14 includes a through hole 141 disposed on a center thereof; a second joint 2 includes a column 26 extending outward therefrom, and the column 26 includes an aperture 261 mounted therein, such that the first and the second joints 1 and 2 are screwed together by ways of a locking element 5, and an adjusting member 3 is fixed between the first joint 1 and the second joint 2.

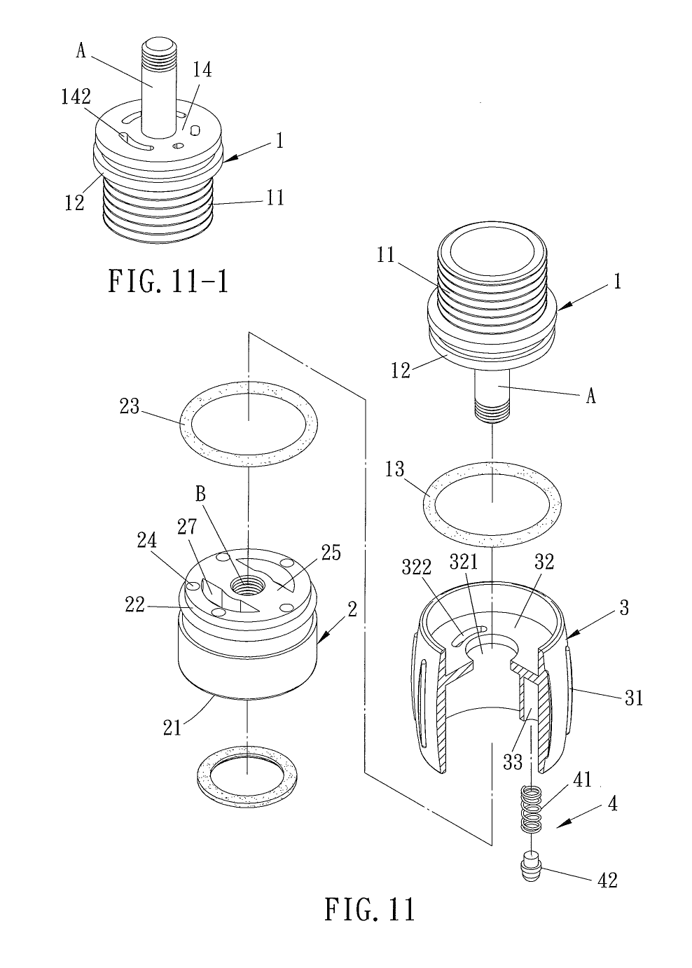

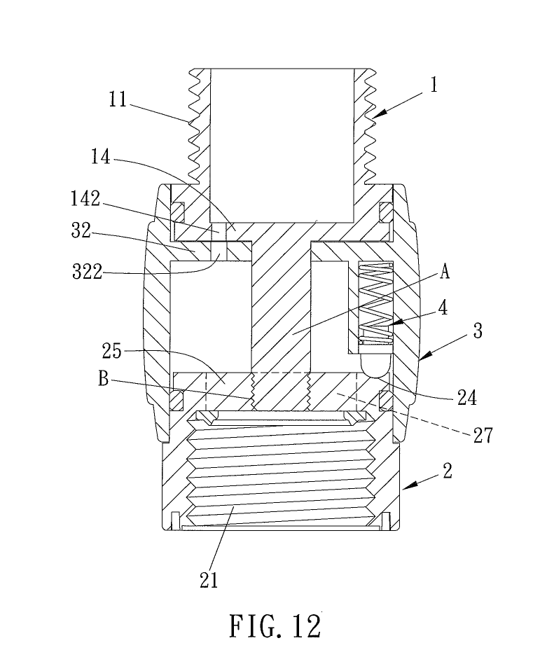

With reference to FIGS. 11 and 12, a joint structure for controlling water flow in accordance with a third embodiment of the present invention comprises a first joint 1 includes a closed surface 14, and a second joint 2 includes a plate 25, wherein the closed surface 14 of the first joint 1 includes a post A with threads extending outward therefrom, and the plate 25 of the second joint 2 includes a screwed pore B arranged on a middle section thereof, such that the post A is screwed with the screwed pore B so that the first and the second joints 1, 2 are screwed together, and an adjusting member 3 is defined between the first joint 1 and the second joint 2.

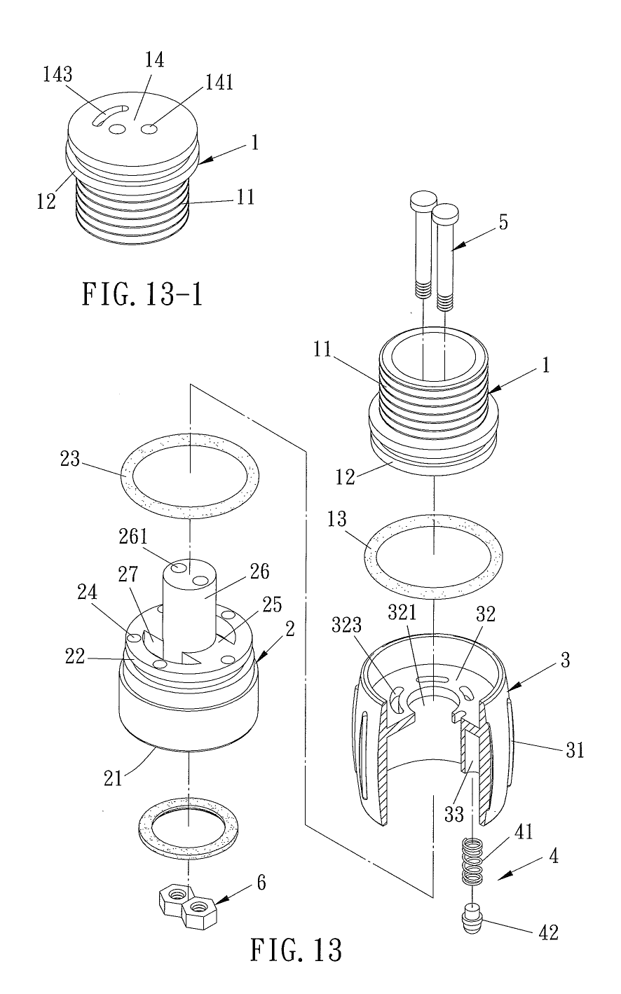

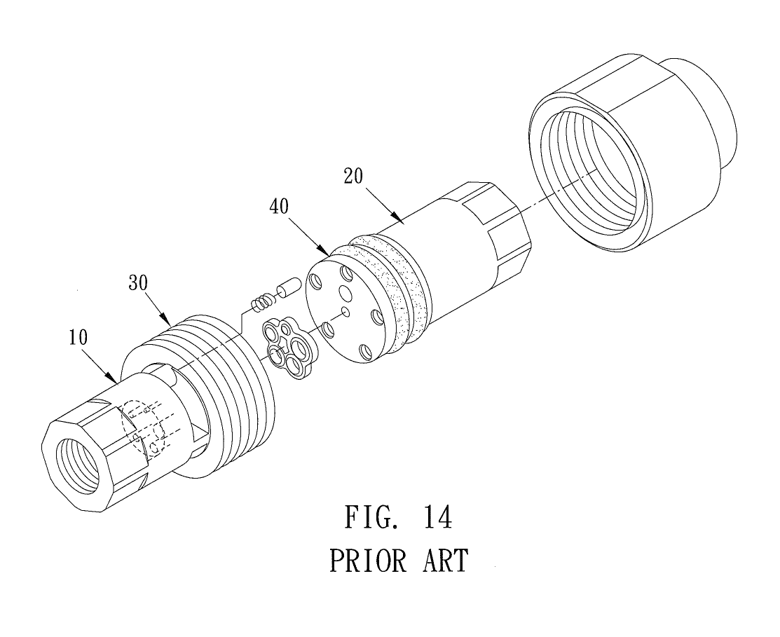

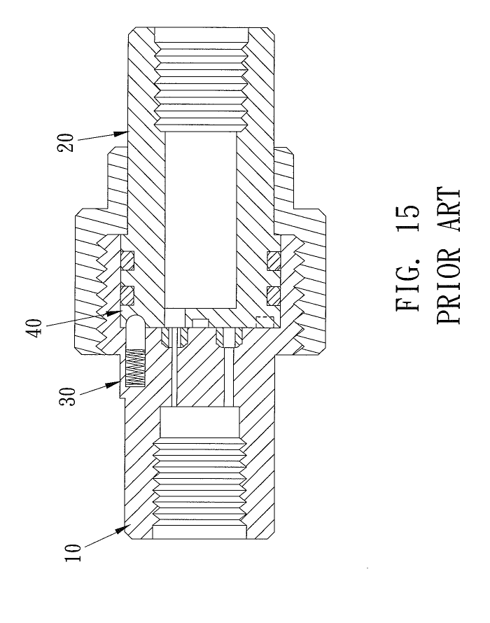

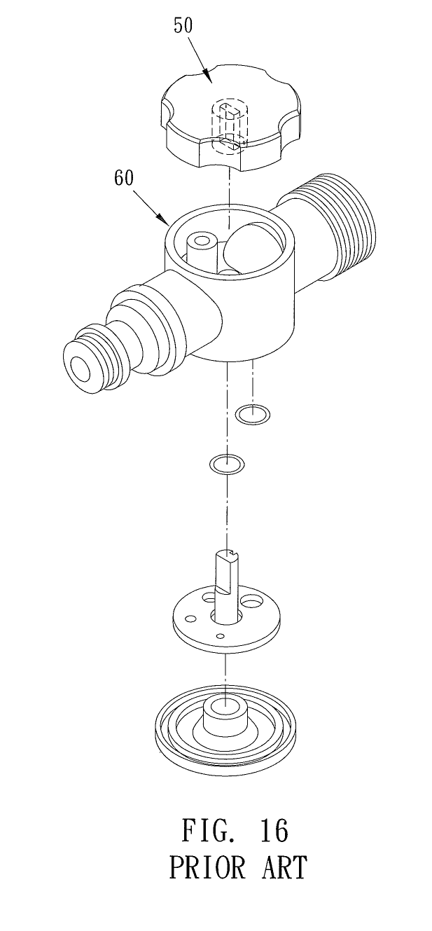

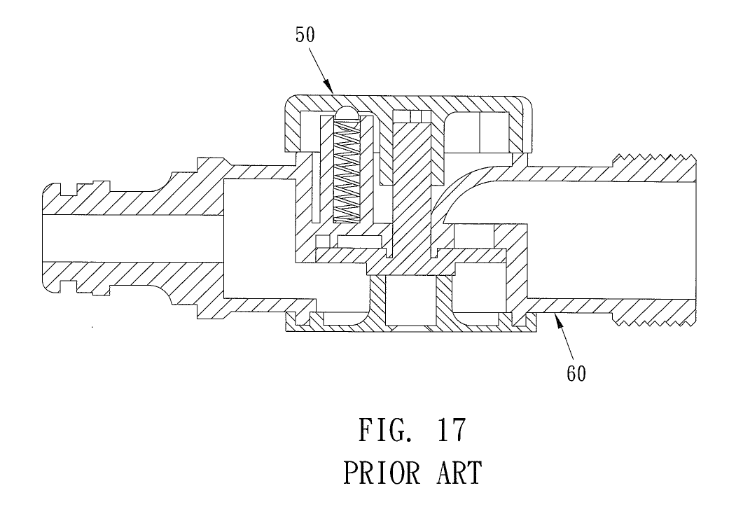

As shown in FIG. 13, a joint structure for controlling water flow in accordance with a fourth embodiment of the present invention comprises a first joint 1 includes a closed surface 14, and the closed surface 14 includes an elongately arcuate limiting bore 143 disposed thereon; an adjusting member 3 includes a partition 32 mounted therein, and the partition 32 includes a number of elongately arcuate orifices 323 fixed thereon, such that the adjusting member 3 is rotated based on requirement to change an engagement between the limiting bore 143 of the first joint 1 and the arcuate orifices 323 of the adjusting member 3 so as to control water flow, thereby saving water and enhancing watering pressure.

It is to be noted that a length of the orifice 322 is larger than a distance between the limiting bores 142, and a length of the limiting bore 143 is larger than a distance between the orifices 323 to keep the joint structure being in an open state normally.

Thereby, the jointing structure of the present invention has the following advantages:

1. As desiring to adjust water flow, the adjusting member 3 is rotated directly, and the first and the second joints 1, 2 are still to prevent the outlet pipes 7 and 8 from deformation so that water flows directly and smoothly without being stopped.

2. As desiring to adjust water flow, the adjusting member 3 is rotated directly, and the first and the second joints 1, 2 are still to prevent the outlet pipes 7 and 8 from being actuated to rotate by the adjusting member 3, such that the joint structure is applicable to hard pipes, and the adjusting member 3 is installed between the first and the second joints 1, 2 to be on the same axle center as the first and second joints 1, 2, hence the adjusting member 3 is operated easily without being limited.

While we have shown and described various embodiments in accordance with the present invention, it is clear to those skilled in the art that further embodiments may be made without departing from the scope of the present invention.

What is claimed:

1. A joint structure for controlling water flow comprising
a first joint being hollow, including a first connecting portion disposed on one end thereof, and including a larger-diameter fitting portion mounted on another end thereof to receive a first stopping ring, including a closed surface fixed on a top end of the larger-diameter fitting portion, and the closed surface including a plurality of limiting bores attached thereon;
a second joint being hollow, including a second connecting portion disposed on one end thereof, including a small-diameter fitting portion mounted on another end thereof, and including openings defined therein;
an adjusting member formed in a circular cylinder and including a partition mounted therein, the partition including an orifice formed thereon, and two ends of the adjusting member being used to fit the first and the second joints axially so that the first joint is connected with the second joint, and the adjusting member is located between the first and the second joints to rotate relative to the first and the second joints.

2. The joint structure for controlling water flow as claimed in claim 1, wherein the first connecting portion of the first joint is an outer connecting portion, and the second connecting portion of the second joint is an inner connecting portion.

3. The joint structure for controlling water flow as claimed in claim 1, wherein the first joint is connected with the second joint by using two locking elements and nuts.

4. The joint structure for controlling water flow as claimed in claim 1, wherein the first joint is connected with the second joint by using one locking element and a nut.

5. The joint structure for controlling water flow as claimed in claim 1, wherein the first joint includes a post with threads extending outward therefrom, and the second joint includes a screwed pore arranged on a middle section thereof, such that the post is screwed with the screwed pore.

6. The joint structure for controlling water flow as claimed in claim 1, wherein the limiting bores and the orifice are formed in an elongated circle shape.

7. The joint structure for controlling water flow as claimed in claim 1, wherein the second joint includes a number of curve fixing notches fixed around a top end surface of the small-diameter fitting portion, and the adjusting member includes a receiving seat arranged therein to receive a positioning unit.

8. The joint structure for controlling water flow as claimed in claim 7, wherein the positioning unit is comprised of a spring and a biasing element.

9. The joint structure for controlling water flow as claimed in claim 1, wherein that length of the orifice is larger than a distance between the limiting bores.
